(19) United States
(12) Patent Application Publication
(10) Pub. No.: US 2014/0042038 A1
(43) Pub. Date: Feb. 13, 2014

(54) MICROFLUIDIC ELECTROCHEMICAL GENOTYPING SYSTEM

(71) Applicant: Shekhar Bhansali, Tampa, FL (US)

(72) Inventor: Shekhar Bhansali, Tampa, FL (US)

(73) Assignee: UNIVERSITY OF SOUTH FLORIDA, Tampa, FL (US)

(21) Appl. No.: 14/057,644

(22) Filed: Oct. 18, 2013

Related U.S. Application Data
(63) Continuation of application No. 12/423,547, filed on Apr. 14, 2009.
(60) Provisional application No. 61/044,694, filed on Apr. 14, 2008.

(51) Int. Cl. G01N 27/48

(52) U.S. Cl. CPC G01N 27/48
USPC 205/777.5; 204/403.01; 204/403.14; 205/792

(57) ABSTRACT

The present invention provides an electrochemical devices and methods for detecting, measuring or monitoring gene expression by detecting hybridization of nucleic acids to arrays. A support wafer with at least one immobilized detection spot is joined with a well-generating wafer to form a sample well above each detection spot. Electrodes transmit electrical impulses upon sample detection from the sample well to an output connector, which are then read by an automated measurement device. The electrode is disposed on either the support wafer, well generating wafer, or on an electrode support wafer. An enzyme-associated probe detects hybridization of molecules to the array, through generation of electrical impulses. Optionally, electron transport mediators and dyes are used in conjunction with the enzyme to aid in detection.

### CROSS REFERENCE TO RELATED APPLICATION

This application is a continuation of U.S. Non-provisional patent application Ser. No. 12/423,547, entitled “Microfluidic Electrochemical Genotyping System, filed Apr. 14, 2009, which claims priority to pending U.S. Provisional Patent Application No. 61/044,694, entitled “Microfluidic Electrochemical Genotyping System”, filed on Apr. 14, 2008, the contents of which are herein incorporated by reference.

### FIELD OF INVENTION

This invention relates to testing of biological molecules. Specifically, the invention entails using electrochemical devices to detect nucleic acids.

### BACKGROUND OF THE INVENTION

DNA, RNA, protein, etc. are routinely used as biomarkers and for sequencing. In some methods, genomic DNA and the RNA are analyzed by hybridizing the genomic DNA or an amplification product to a probe (collectively, genomic material). (Carrico, U.S. Pat. No. 4,833,084, May 23, 1989; Stuart et al., U.S. Pat. No. 4,732,847). Each array has probes designed for analyzing a particular polymorphism according to the strategy described above. These probes are complementary to a specific polymorphism, and hybridized or otherwise fixed to a solid support, which is typically a polymer substance. The probes act as receptors for the genomic material and bind to genetic material which possesses a complementary sequence of bases. The probe is tagged with a fluorescent reporter group or marker which emits light upon radiation with light of a suitable wavelength. The array is optically scanned by sequentially irradiating the probes in a rectangular pattern and sensing the emitted light intensity at each probe location.

Such methods depend on hybridization of probe oligonucleotides to recognize short subsequences, typically of 4 to 20 base pairs on target nucleic acids. The oligonucleotides can be either present in solution or arrayed on a planar surface, such as a glass chip (“chip”).

Microarray technology can be advantageously applied is disease management, as microarrays permit rapid and accurate analysis of relevant genetic information which may be utilized in diagnosis into a high-value disease management paradigm. Microarrays are useful in patient management, and may be used to determine infectious disease, cancer and drug metabolism. This enables researchers to understand the genetic basis and progression of disease and patient response to treatment. Correlatation between mutations and patient outcome under varied therapeutic drug regimes are permitting detailed prognoses, drug therapies and treatment strategies.

DNA microarrays, consisting 60 of thousands of DNA sequences printed at high density on a solid support, can be used for large-scale gene expression analysis (Ramsey, 1998, Nat. Biotechnol. 16:40̂14; Marshall and Hodgson, 1998, Nat. Biotechnol. 16:27-31). The microarray chips can be prepared by depositing synthesized probe oligonucleotides on a derivatized glass surface, or by synthesizing the probe oligonucleotides directly on the glass surface using a combination of photolithography and oligonucleotide chemistry (Lashkari et al., 1997, Proc. Nat. Acad. Sci. USA 94:13057-13062; DeRisi et al., 1997, Science, 278:680-686; Wodicka et al., 1997, Nat. Biotechnol. 15:1359-1367; Chee et al., 1996, Science 274:610-614). These probe oligonucleotides are typically designed to hybridize to 10, 15, or 20 bases of a target DNA. Microarray chips capable of recognizing in principle up to 6500 genes have been prepared. (GeneChip® Probe Array, Affymetrix, Inc., Santa Clara, Calif.). The chips are hybridized to samples of fluorescently tagged target DNAs, and are then imaged to determine to which oligonucleotides hybridization has occurred. Total cDNA or mRNA samples can be used with this procedure, so that expression of thousands of genes in complex mixtures of cellular mRNA species can be simultaneously monitored (DeRisi et al., 1997, Science 278:680-686). This permits the detection within a defined cell population of characteristic transcript “signature” patterns which may be perturbed in characteristic ways by genetic mutations (DeRisi et al., supra), or manipulations of experimental conditions (DeRisi et al., supra; Wodicka, L., et al., 1997, Nat. Biotechnol. 15:1359-1367). The latter finding suggests that DNA microarrays may be useful for distinguishing desirable or undesirable effects during drug screening.

Most approaches rely on optical detection of the fluorescently tagged gene and require significantly large (nanomolar) concentrations of the sample, which may be achieved through sample amplification, such as PCR. A hybridized gene probe array is optically scanned by irradiating the individual probes with light of a certain wavelength, and sensing the light intensity resulting from fluorescence of the probes. The fluorescent intensity increases with the bonding strength of a ligand to a receptor. Since the probe sequence at each location is known, the unknown genomic material can be identified as being complementary to the probe which produces the greatest value of fluorescent intensity. However, the optical scanners are incapable of providing useful intensity readings for very high or very low levels of fluorescent intensity. This was due to a limitation in the range of detection (dynamic range) of the photomultiplier tube in the optical scanners. Although it is possible to reduce the gain of the tube to prevent saturation, this may result in loss of sensitivity and accuracy at the low end of the range.

For assay of genomic DNA, virtually any biological sample, except pure red blood cells, is acceptable. DNA collected from sources such as convenient tissue samples include whole blood, semen, saliva, tears, urine, fecal material, sweat, buccal, skin and hair, is typically by PCR to a suitable fragment size by PCR.

Arrays can be designed to analyze many different polymorphisms in many different genes simultaneously simply by including multiple arrays of probes. However, the observational methods for gene expression described above are not capable of rapidly, accurately, and economically observing and measuring the presence or expression of selected individual genes or of whole genomes. Further, most of these techniques are still qualitative and unable to quantify the concentration of the target.

### SUMMARY OF THE INVENTION

The present invention relates to devices and methods for detecting, measuring or monitoring gene expression by detecting hybridization of nucleic acids to arrays. Previous techniques to detect hybridization on nucleic acid arrays are tedious, time consuming, and relatively insensitive. The present invention provides a sensitive, specific method for detecting and quantitatively measuring hybridization on nucleic acid targets to arrays to electrochemically detect hybridization of target molecules to probe. The disclosed detection approach eliminates the need to concentrate DNA or RNA using PCR, sequencing, or large sample volumes used in biomarker detection. The technique has effectively been used at femtomolar and attomolar concentrations. This reduces the cost and time of detection, while increasing the ease of testing and quantification.

Accordingly, an electrochemical microarray device is disclosed. The microarray uses a support wafer with at least one detection spot immobilized on the upper surface of the support wafer. A well-generating wafer with sample well-defining openings is fixed to the upper surface of the support wafer. The openings of the well-generating wafer correspond to location of the detection spot or spots, so that at least one well is formed around the detection spot when the well-generating wafer is fixed to the support wafer. The wafers may be constructed of glass, derivatized glass, plastic, silicon, silicon dioxide, nanocrystalline diamond, polydimethylsiloxane, polymethylmethacrylate, SU-8, coated cellulose, coated nitrocellulose, coated plastic, polypropylene, polyacrylamide, nylon, or gold. The microarray uses at least one electrode in electrical communication with the sample well to collect and transmit electrical impulses upon sample detection. In specific embodiments of the invention, the electrode comprises metal, conducting polymer, nanostructure materials, conducting paste, or combinations thereof, and may further be a metal selected from the group consisting of gold, silver, platinum, copper, colloidal gold, colloidal silver, and colloidal platinum. In specific embodiments, the electrode is connected at a first end to the sample well and at a second end to an output connector, adapted to mate with an automated measurement device. The electrode is disposed on either the support wafer, well-generating wafer, or on an electrode support wafer.

The detection spot of the device is adapted to accept a test sample. In specific embodiments, the detection spot further comprises a probe of DNA, DNA mimics, Gruber DNA, RNA, RNA mimics, oligonucleotide, antibody, synthetic oligomer, peptide nucleic acid, full-length cDNA, a less-than full-length cDNA, or a gene fragment. The probe may be fixed to the upper surface of the support wafer by synthesizing the probe directly on the support wafer, photolithography, printing, ink jet printing, piezoelectric printing, drop touch, spotting, electrochemistry, or oligonucleotide chemistry. The probe is optionally associated with an enzyme label, such as horse radish peroxidase, β-galactosidase, or glucose oxidase. In specific embodiments an electron transport mediator is used in conjunction with the enzyme. Exemplary electron transport mediators are ferrocene, isocyanate-derived compounds, phosphines, amines, nanoparticles, ferrocene-containing pyrrole derivatives, ferri/ferro cyanide, and derivitized hydrophilic epoxy cements containing pyridinium-N-ethylamine poly-cations. A dye may also be used in the detection spot to indicate the presence catalyzed product via color changes in the dye.

The invention also indicates a method for detecting biological molecules, such as biomarkers, DNA, RNA, and protein, by exposing a test sample to the device described above and testing the at least one electrode for a signal generated from the at least one detection spot. The method may utilize a probe to detect the biological molecules. Exemplary probes include DNA, DNA mimics, Gruber DNA, RNA, RNA mimics, oligonucleotide, antibody, synthetic oligomer, peptide nucleic acid, full-length cDNAs, less-than full-length cDNAs, and gene fragments. The probes are associated with an enzyme label, thereby enabling generation of an electrical signal. Exemplary enzyme labels include horse radish peroxidase, β-galactosidase, and glucose oxidase. Electrodes are disposed on the support wafer, well generating wafer, or on an electrode support wafer to transfer electrical impulses from the sample wells to a testing unit.

### BRIEF DESCRIPTION OF THE DRAWINGS

For a fuller understanding of the invention, reference should be made to the following detailed description, taken in connection with the accompanying drawings, in which:

FIG. 1 is a diagram of the detection chip with electrodes integrated into the upper layer of the device.

FIG. 2 is a cross-section diagram of the detection chip shown in FIG. 1.

FIG. 3 is a diagram of the detection chip with electrodes integrated into the lower layer of the device.

FIG. 4 is a cross-section diagram of the detection chip shown in FIG. 3.

FIG. 5 is a diagram of the detection chip with electrodes integrated into a third layer disposed on the upper layer of the device.

FIG. 6 is a cross-section diagram of the detection chip shown in FIG. 5.

FIG. 7 is a cross-section diagram of the detection chip with probe electrodes extending from a layer disposed on the upper layer of the device into test wells.

FIG. 8 is a diagram of the redox chemical reactions for horse radish peroxidase using a catechol substrate.

FIG. 9 is a diagram of the redox chemical reactions for β-galactosidase using X-gal as a substrate. The oligosaccharides or glycosyl derivative substrates are cleaved, creating penultimate β-galactose residues.

FIG. 10 is a diagram of the redox chemical reactions for glucose oxidase.

### DETAILED DESCRIPTION OF THE PREFERRED EMBODIMENT

The present invention provides an electrochemical detection cell system and method of detecting biological samples. The device consists of a two layers with a capture antibody and integrated electrodes. The electrodes may be integrated into the top layer or bottom layer depending on the detection approach used. The device is processed conventionally, with samples applied to distinct sample wells. The samples react with detection molecules are measurements taken with the electrodes. This approach eliminates the need to concentrate DNA or RNA using PCR, sequencing, or large sample volumes used in biomarker detection, reducing the cost and time of detection, while increasing the ease of testing and quantification.

A “probe” is a nucleic acid sequence, including DNA, DNA mimics, RNA and RNA mimics, oligonucleotide, or antibody that is complementary to at least a subsequence of the RNA or DNA desired to be detected. The DNA, DNA mimic, RNA, or RNA mimic may be a synthetic oligomer, a full-length cDNA, a less-than full-length cDNA, or a gene fragment. The array may also contain nonsense or non-complementary probes for normalization controls, mismatch controls and expression level controls. Nucleic acids may be modified for use as a probe at the base moiety, sugar moiety, or phosphate backbone. DNA can be obtained by, e.g., polymerase chain reaction (PCR) amplification of gene segments from genomic DNA, cDNA (e.g., by RT-PCR), or cloned sequences. An alternative means for generating the nucleic acids for the microarray is by synthesis of synthetic polynucleotides or oligonucleotides, e.g., using N-phosphonate or phos-phoramidite chemistries (Froehler et al., 1986, Nucleic Acid Res 14:5399-5407; McBride et al., 1983, Tetrahedron Lett. 24:245-248). The synthetic nucleic acids may include non-natural bases, e.g., inosine., generating nucleic acid analogues. (see, e.g., Egholm et al., 1993, Nature 365:566-568; U.S. Pat. No. 5,539,083). The probes may alternatively be generated from plasmid or phage clones of genes, cDNAs (e.g., expressed sequence tags), or inserts therefrom (Nguyen et al., 1995, Genomics 29:207-209). Antibodies may include, but are not limited to, polyclonal antibodies, monoclonal antibodies (mAbs), humanized or chimeric antibodies, single chain antibodies, Fab fragments, F(ab′)2 fragments, fragments produced by a Fab expression library, anti-idiotypic (anti-Id) antibodies, and epitope-binding fragments of any of the above.

As used herein, a “microarray” is a solid phase surface with an ordered array of nucleic acids that provide hybridization sites for products of many of the genes in the genome of a cell or organism, and can be used to detect most or almost all of the genes. Microarrays consist of a surface to which probes that correspond in sequence (i.e. comprise the inverse complement and can therefore hybridize) to DNA, RNA or other nucleic acid, can be specifically hybridized or bound, preferably at a known position. Each probe has either the same or different sequence. The position of each probe on the solid surface is preferably known. The microarray may comprise a single probe or multiple probes, such as an array (i.e., a matrix) in which each position represents a discrete binding site for a DNA or RNA anlayte. The microarray may possess binding sites for most or almost all of the genes in the organism's genome.

Microarrays can be made in various means, as known in the art. Exemplary methods include attaching probes to a solid support, such as glass, polypropylene, nylon, plastic, polyacrylamide, nitrocellulose. The probe may be attached by printing on glass plates (Schena et al., 1995, Science 270:467-70; DeRisi et al., 1996, Nature Genetics 14:457-460), or use of an ink jet printer (Blanchard U.S. application Ser. No. 09/008,120, filed Jan. 16, 1998). Alternatively high-density oligonucleotide arrays may be generated directly on the support as known in the art (see, Fodor et al., 1991, Light-directed spatially addressable parallel chemical synthesis, Science 251:767-773; Pease et al., 1994, Light-directed oligonucleotide arrays for rapid DNA sequence analysis, Proc. Natl. Acad. Sci. USA 91:5022-5026; Lockhart et al., 1996, Expression monitoring by hybridization to high-density oligonucleotide arrays, Nature Biotech 14:1675; U.S. Pat. Nos. 5,578,832; 5,556,752; and 5,510,270; Blanchard et al., 1996, High-Density Oligonucleotide arrays, Biosensors & Bio-electronics 11: 687-90). These methods synthesize probes directly on a surface such as a derivatized glass slide.

Microarrays are reproducible, allowing multiple copies of a given array to be produced and easily compared with each other, and are typically small. The microarray is generally an array of less than 6.25 cm² in size (although the contiguous solid phase can be much larger). Generally, a microarray is about 1.6 cm² to 6.25 cm² in size, and usually smaller than 5 cm². The arrays are made from materials that are stable under binding (e.g. nucleic acid hybridization) conditions. A given binding site or unique set of binding sites in the microarray will specifically bind the product of a single gene in the cell, as dictated by the probe associated with the binding site. Microarrays can be employed for analyzing the transcriptional state in a cell, e.g., for measuring the transcriptional states of cells exposed to graded levels of a drug of interest or to graded perturbations to a biological pathway of interest.

“Target nucleic acids” or “nucleic acid analyte” as used herein are nucleic acids comprised of DNA or RNA or mimics (derivatives, analogues) thereof. The target nucleic acids may be total cellular DNA or RNA, poly(A)+ messenger RNA (“mRNA”), fractions thereof, cDNA, or RNA transcribed from cDNA. The Target nucleic acids are extracted from cells of interest, which may include without limiting the scope of the invention wild-type cells, drug-exposed wild-type cells, modified cells, diseased cells, and cancer cells.

The present invention employs, unless otherwise noted, conventional techniques of cell biology, cell culture, molecular biology, microbiology, recombinant DNA, immunology, transgenic animal technology, and pharmacology. See, e.g., Sambrook et al., Molecular Cloning A Laboratory Manual, Cold Spring Harbor Press, (2nd. ed., 45 1989); Glover ed., DNA Cloning, Vol 1 and 2 (1985); Gait ed., Oligonucleotide Synthesis (1984); Hames et al. eds., Transcription and Translation (1984); Freshney, Culture of Animal Cells, Alan N. Liss, Inc. (1997); Immobilized Cells and Enzymes, IRL Press (1986); Perbal, A Practical Guide 50 to Molecular Cloning, Methods in Enzymology, Academic Press (1984); Miller et al. eds., Gene Transfer Vectors for Mammalian Cells, Cold Spring Harbor Laboratory (1987); Wu et al. eds., Methods in Enzymology, Vols 154 and 155; Mayer et al. eds., Immunochemical Methods in Cell and 55 Molecular Biology, Academic Press (1987); Weir et al. eds., Handbook of Experimental Immunology, Vols 1-4 (1986).

Measurement of gene expression is made by hybridization of nucleotide to microarrays consisting of a probe or population of probes immobilized on the surface of a support. Prior to immobilizing probe onto a microarray, the glass substrate should be derivatized. Glass slides of 25×75×1 mm (Catalog #12-552, Fisher Scientific, Pittsburgh, Pa.) are prewashed 5-6 times in distilled water, followed by soaking in 1 M NaOH for 4 hrs at room temperature. The glass was then rinsed several times with distilled water until the pH of the wash was about 7.0. The glass slides were then soaked between 4 hrs to overnight in fuming nitric acid and rinsed with dH2O until pH of the wash was 7.0, followed by air-drying. The glass support surfaces were derivatized with covalently bound isothiocyanate groups. Probes were then prepared, as is known in the art. Robotic methods were used to spot the probe solutions onto the derivatized glass surface (Shena et al, 1996, Proc. Natl. Acad. Sci. USA, 93:10614 and DeRisi et al., 1997, Science, 278:680-686).

One of the ways in which the probe can be detectably labeled is by linking the probe to an enzyme. The enzyme that is bound to probe will react with an appropriate substrate, preferably a chromogenic substrate. The probe may be labeled before contacting the array. As an alternative to using labeled probe to detect or measure probe-target heteroduplexes on the array, the probe may be immobilized to the array as unlabeled probe. The probe is allowed to contact with target nucleic acid and form heteroduplexes and subsequently detected by contacting the surface of the array with a labeled detector. For example, an antibody detector against the heteroduplex or target nucleic acid may be used. If the probe used is an antibody, the detector is human or murine antibody, such as labeled goat anti-human or goat anti-mouse antibody directed against a portion of the probe antibody. In some variations, the labeled detector antibody is linked to an enzyme. For DNA processing, a Gruber DNA with an enzyme label is used, whereas biomarkers are subjected to classical immunoassay

Target nucleic acid hybridization and wash conditions are known in the art and are chosen so that the target nucleic acids “specifically bind” or “specifically hybridize” to complementary probe sequences immobilized on the array. As used herein, one polynucleotide sequence is considered complementary to another when there is no more than a 5% mismatch. In certain embodiments, the polynucleotides are perfectly complementary (no mismatches). It can easily be demonstrated that specific hybridization conditions result in specific hybridization by carrying out a hybridization assay including negative controls (see, e.g., Shalon et al., supra, and Chee et al., supra). Arrays containing double-stranded probe DNA situated thereon may be subjected to denaturing conditions to render the target DNA single-stranded prior to contacting with probe. Arrays containing single-stranded probe DNA (e.g., synthetic oligodeoxyribonucleic acids) need not be denatured prior to contacting with the target RNA.

Optimal hybridization conditions depend on the length, such as oligomer versus polynucleotide greater than 200 bases, and type, i.e. RNA or DNA, of probe and target nucleic acids. General parameters for specific hybridization conditions for nucleic acids are known in the art (See, Sambrook et al., supra, and in Ausubel et al., 1987, Current 60 Protocols in Molecular Biology, Greene Publishing and Wiley-Interscience, New York). When cDNA probes are used in microarrays, typical hybridization conditions are hybridization in 5×SSC plus 0.2% SDS at 65° C. for 4 hours, followed by washes at 25° C. in low stringency wash buffer 65 (1×SSC plus 0.2% SDS) followed by 10 minutes at 25° C. in high stringency wash buffer (0.1×SSC plus 0.2% SDS) (Shena et al., 1996, Proc. Natl. Acad. Sci. USA, 93:10614). Other useful hybridization conditions are also known in the art (Tijessen, 1993, Hybridization With Nucleic Acid Probes, Elsevier Science Publishers B. V. and Kricka, 1992, Nonisotopic DNA Probe Techniques, Academic Press San Diego, Calif.). For example, microarrays utilizing antibody probes may use conditions optimizing immunospecific binding between the antibody and any target nucleic acid in the array. Typically, a buffered (pH 7-9) physiological saline solution containing 0.1% bovine serum albumin is used.

The detection medium used may be any material known in the art and which either generates or assists in generating electrical current when associated with analyte. In general, an electrochemical analysis performed using the disclosed methods and biosensor requires no more than about 10 or 15 minutes to perform. The signals generated are typically proportional to the amount (concentration) of target nucleic acid present in the sample.

The electrochemical assays can be automated in a number of ways using relatively inexpensive equipment and procedures that are generally more robust and less complex for the operator to perform than comparable immunoassays. This allows use of samples regardless of the optical characteristics. Additionally, the results are provided as a quantitative measurement.

### Example 1

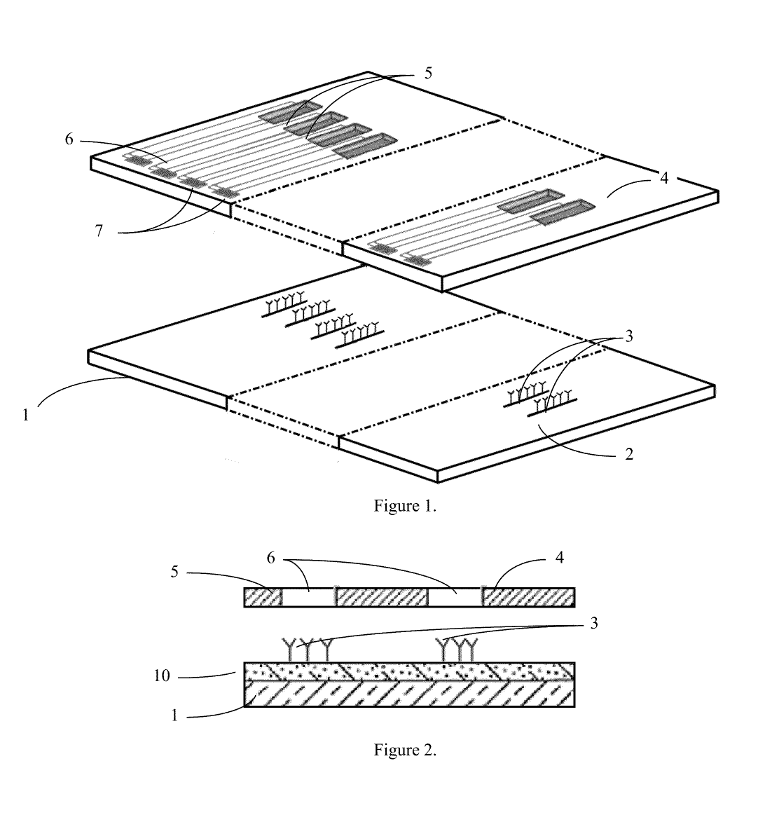

The device includes of a bottom layer with a capture antibody and a microwell layer, as seen in FIG. 1. Detection molecule 3 was spotted onto support wafer 1, thereby forming detection spots 2, as seen in FIG. 1 The detection spots may be placed at known locations on the support wafer, forming either a macroarray or microarray useful for detecting samples, especially DNA, RNA, or protein. At least one well 5 is removed from microwell wafer 4. The wells shown are rectangular, but any shape found useful in the art may be used, such as a circular hole. Electrodes 6 are integrated into microwell layer 4, allowing measurements to be taken from the upper surface of the device, for example by automated measurement heads. Electrodes 6 comprise a reference electrode and working electrodes. Microwell wafer 4 is attached to the upper surface of support wafer 1, such that well 5 aligns with detection spot 3, seen in FIG. 2. Once microwell wafer 4 is attached to support wafer 1, an interstitial space is formed above detection spot 3, allowing a user to place a liquid analyte into well 5. Electrode 6 extends into well 3.

Once assembled, target nucleic acids are added to the interstitial region defined by the walls of well 5 and the upper surface of support wafer 1. The hybridization of target nucleic acid with probe occurs in an aqueous environment conducive to hybridization. Such environments are known in the art. Upon completion of hybridization of the target nucleic acid and probe, the interstitial space is washed to remove excess unbound target nucleic acids. The signal is then detected electrochemically, as discussed. The electrical signal generated or potentiated by the target nucleic acid-probe heteroduplexes are transferred by a terminal of electrode 6, located within the interstitial space, along the electrode to output connector 7.

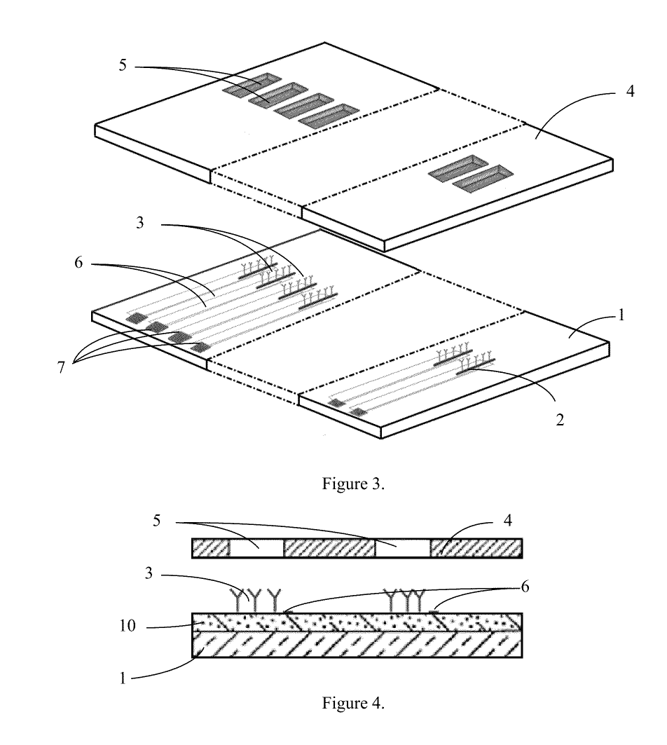

Conversely, the electrodes can be integrated in the bottom layer, as seen in FIG. 3. In this variant of the microarray, electrodes 6 are integrated into the upper surface of support wafer 1. One terminal end of electrode 6 end at detection spot 2, with the corresponding other terminal end contacting to output connector 7. As seen in FIGS. 1 and 3, output connector 7 may be mounted to one edge of support wafer 1. Detection molecule 3 was spotted onto support wafer 1, along detection spots 2. Well 5 was removed from microwell wafer 4, forming four walls used to define the interstitial space for loading and hybridization of target nucleic acid. Microwell wafer 4 is attached to the upper surface of support wafer 1, such that well 5 aligns with detection spot 2, and forms an interstitial space housing detection molecule 3 and the terminal end of electrode 6, seen in FIG. 4.

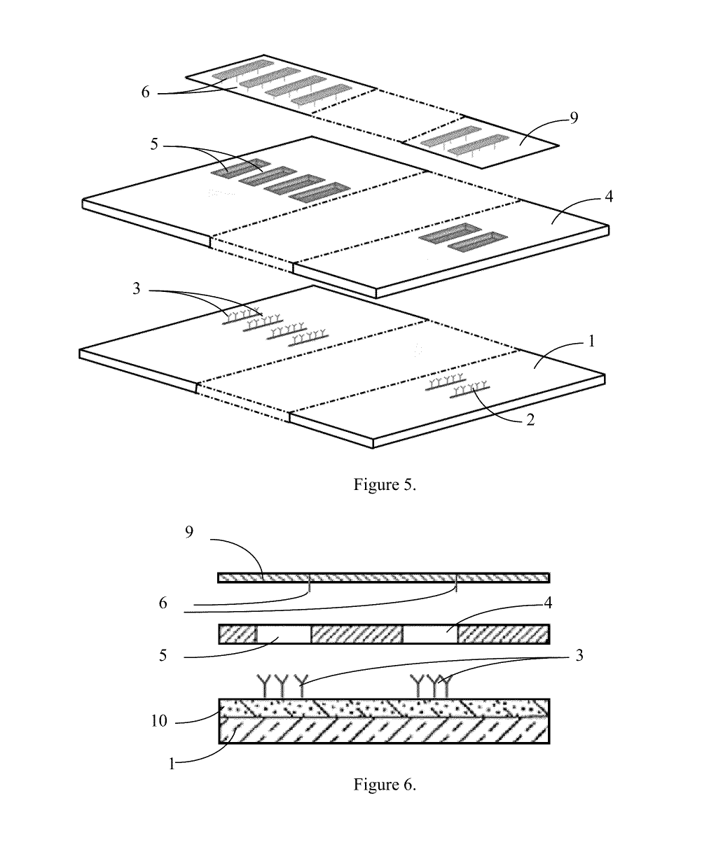

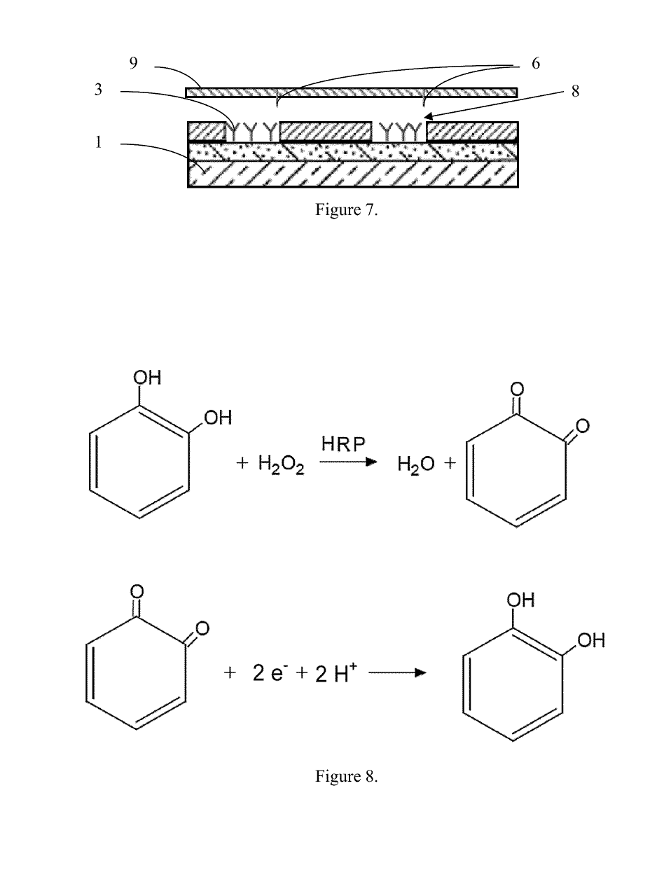

In an alternative variant, electrodes 6 are integrated into electrode wafer 9, seen in FIG. 5. Support wafer is spotted with detection molecule 3 on the upper surface of support wafer 1, thereby forming detection spots 2. Microwell wafer 4 with at least one well 5 is attached to the upper surface of support wafer 1, such that well 5 aligns with detection spot 2. Once microwell wafer 4 is attached to support wafer 1, an interstitial space is formed, defined by the walls of well 5 and the upper surface of support wafer 1, which houses detection molecule 3, as seen in FIG. 6. The device formed from the attachment of microwell wafer 4 with support wafer 1 forms a disposable chamber. Electrode wafer 9 comprises at least one electrode 6, which corresponds to well 5, so that the electrodes fit into interstitial space 8, as seen in FIG. 7. The electrodes may be integrated with the disposable chamber. The electrodes are placed in the solution, if not integrated into the device. Measurement readings are then taken through the electrodes using a multi-channel recorder.

In some variants, support coating 10 is applied to the upper surface of support wafer 1, as seen in FIGS. 2, 4, and 6. Support coating 10 may be used to enhance the immobilization of detection molecule 3.

Signals are transmitted through working electrodes. The electrodes may be screen-printed on the test strip together with a reference electrode, such as silver electrodes or carbon electrodes. The system can be used to probe multiple samples for one or more gene variations. Strong signals from a particular element in the array are indicative of the presence of gene variations in that sample.

The material used in microwell wafer 4 support wafer 1, and electrode wafer 9 may be silicon, glass, silver, cellulose (paper), nitrocellulose, polypropylene, nylon, polyacrylamide, or plastic. Other useful materials for manufacture of the wafers include silicon dioxide, nanocrystalline diamond, polydimethylsiloxane, polymethylmethacrylate, SU-8 (Khanna, P., et al., Use of nanocrystal diamond for microfluidic lab-on-a-chip, Diamond & Related Mat., 15 (2006); 2073-2077). The wafer may be appropriately coated to permit immobilization of probe and/or prevent absorption of target nuclei acid onto the wafer. Additionally the strip could also have a dye that changes color when exposed to the catalyzed product-thus also providing a visual recognition.

The electrodes are made from any electrically conductive material known in the art. Exemplary materials include metals such as gold gold, silver, platinum, and copper; conducting polymers, such as oxidized polyacetylene, polypyrrole and polyaniline, iodine-doped polypyrrole, Poly(phenylene vinylene), poly(acetylene)s, poly(pyrrole)s, poly(thiophene)s, poly(aniline)s, poly(fluorene)s, poly(3-alkylthiophene)s, polytetrathiafulvalenes, polynaphthalenes, poly(p-phenylene sulfide), and poly(para-phenylene vinylene); and conducting pastes, such as those described in WO/1991/005347. The electrodes, for example nanowire electrodes, are integrated with the bottom or the top chamber, depending on the detection approach. For microwell measurements, the electrodes are integrated with the interstitial chamber and output connector for the automated measurement heads. The electrodes are applied or patterned through printing, photolithography, electrochemistry, lift off application, or grown. Nanostructures, such as wires and particles, may be grown or attached to the electrode areas, as is known in the art.

### Example 2

The electrochemical genotyping device is useful in detecting duplex formation (e.g. nucleic acid sequence-nucleic acid sequence, nucleic acid sequence-protein, protein-small molecule, or protein-protein) indicative of probe-target hybridization. A probe, such as a nucleic acid sequence, is bound to a support comprising a conductive material, like gold. The support-bound probe nucleic acid sequence is exposed to a nanoparticle comprising a target nucleic acid sequence associated with a central component. Complementary nucleic acid sequences hybridize to form hybridized duplexes.

The electrochemical cell comprises two or more electrodes. One electrode serves as a reference electrode and one is a working electrode. The electrode array, i.e. one reference electrode and one to two working electrodes, is present for each different probe-target complex one desires to detect. Where two electrodes are present, the current flows between the working and reference electrodes. Alternatively, three electrodes are present; a working, a reference and a counter electrode, with the current flows between the working and the counter electrodes. The working electrodes may be ultramicro-arrays of gold printed on the surface of the array. Alternatively, colloidal gold particles may be applied to the surface.

In a one probe assay method, a probe that comprises an oligonucleotide segment is hybridized to a target nucleic acid segment and coupled to a working electrode such that when an amperometric potential is applied across the working electrode, a current is generated which flows between the working electrode and another electrode. The latter electrode may be a reference electrode or preferably a third electrode, designated as a counter electrode.

A potentiostat or other electrometric device serves to measure current generated between the working electrode either a reference or counter electrode. Working electrodes arrays of colloidal gold particles have proven to be effective, however it is contemplated that bulk metals as well as colloidal or fine particulate metals may also be employed. Colloidal metals include gold, silver and platinum. Particulate metals may include gold, silver, platinum, and copper.

An important aspect of the present invention is an electroactive label coupling which promotes a strong, quantifiable catalytic current when a “bridge” is made by hybridization of the probe with its complementary target. At the molecular level, this “bridge” places the electroactive label in close proximity to the electrode, such that a current is generated when an amperometric potential is applied across the working and reference electrodes. The captured target is then electrochemically detected by applying an amperometric potential across a working electrode and a reference electrode to generate a current that then flows between the working electrode and one other electrode. Measurement of such a current indicates the presence of the target nucleic acid segment.

Optionally, the support and any bound duplexes can subsequently be exposed to a secondary component, which comprises a redox compound, like ferrocene (discyclopentadienyl iron), isocyanate groups, phosphines and amines. The redox compound can be labeled with an alkane thiol. After forming duplexes on a support, or after treating the support with a secondary component, a current is applied to the support, which acts as an electrode. When an electrical current is applied to the support, current travels through the support and interacts with the central component of a bound nanoparticle to generate a signal. The signal is amplified by the presence of the many redox active particles causing current to flow toward the working electrode, completing a circuit and generating a detectable signal.

A nanoparticle itself can serve as a “redox-active signal”. That is, a single gold nanoparticle comprises tens of thousands of gold atoms that can be oxidized to Au³⁺μions. This oxidation reaction can be detected electrochemically. This approach offers the advantage that the amplification factor is very large.

The potential imposed on an electrochemical cell of the invention may be constant, such as provided by a potentiostat and which measures a resulting steady-state current, or a “pulsed” potential, i.e. a series of brief, intermittent potentials of generally constant amplitude that are applied or pulsed through the electrochemical cell. The pulses may also alternate between two voltage levels on each side of a common voltage level. Where a pulsed potential is intermittent, the potential is simply disconnected from the electrochemical cell at intervals. The electrochemical potential pulses confine the electrochemical reaction to specific short intervals thereby minimizing depletion of reporter molecules at the surface of the working electrodes and enabling repetitive measurements and acquisition of large number of data points thus increasing sensitivity at least 10-fold. The printed biosensor array is particularly useful for intermittent electrochemical pulse measurements because as little as 10 seconds is sufficient to stabilize the intermittent pulse signal; high density working electrode arrays with electrode sizes <1 mm require the sensitivity, precision, and reproducibility of intermittent pulse detection for optimal response; and a single potentiostat, with suitable multiplexing capability, can be used for simultaneous measurements of arrays of sensors.

An intermittent pulse amperometry (IPA) monitoring system, using a series of millisecond constant potential pulses separated by short open circuit periods, are used to obtain simultaneous and independent measurements of the target nucleic acids using low or high-density sensor arrays. IPA measurements typically use currents that are significantly larger than those measured by conventional DC amperometry (DCA), providing a more precise and accurate measure of currents from very low target concentrations.

### Example 3

The electrochemical genotyping device is also useful in detecting probe-target hybridization duplex formation through localized generation of electrical impulses. The localized electrical generation is described for redox reactions, but may occur by any means known in the art.

The electrochemical cell comprises two or more electrodes, forming a closed circuit. The working electrodes may be ultramicro-arrays of gold printed on the surface of the array, or any other electrode material identified as useful in the art. A probe, such as a nucleic acid sequence, is immobilized to the microarray support near the electrode. The probe nucleic acid sequence is exposed to a target nucleic acid sequence associated with a central component. Complementary nucleic acid sequences hybridize to form hybridized duplexes.

The central component is an inactive enzyme or apoenzyme, prior to hybridization. The electrochemical enzyme is chemically modified by binding an electron transport mediator to the surface of the apoenzyme. For example, ferrocene electron transport mediator molecules may be linked to lysine amino acid residues on the apoenzyme via amide bonds. When reactivated by the enzyme activation factor portion of the test analyte detection moiety, the mediator-modified enzyme may then diffuse and transport electrons directly to electrode surfaces. Upon hybridization of the target nucleic acid and probe, a substrate solution is added to the device. The apoenzyme or inactive electrochemical enzyme itself is bound to the electrode surface or probe, and the mediator is either also bound to the microarray or the target nucleic acid. Once the target nucleic acid and probe are bound, forming a heteroduplex, the enzyme and mediator come into contact, thereby activating the enzyme.

The enzyme may be imbedded in a conducting polymer matrix, such as ferrocene-containing pyrrole derivatives, hydrophilic epoxy cements derivitized to contain electrically conducting pyridinium-N-ethylamine poly-cationic domains, copolymers of allylamine and ferrocene-functionalized acrylic acid, silicon alkoxide sol-gel matrices doped with electron-transfer mediators, and the like. Since the electrochemical enzyme is immobilized onto the electrode surface, these later schemes have the advantage of often being very stable and very sensitive.

As the test reaction progresses, the heteroduplex displaces the prosthetic group, making it available for binding to the prosthetic group binding region of apoenzyme. The binding of the prosthetic group to prosthetic group binding site converts the inactive apoenzyme to an active enzyme, changing the conformation of the enzyme active site and enabling enzymatic activity. In particular, it is now capable of enzymatically altering amplification enzyme substrate, in a reaction that produces a detectable electrochemical change.

These changes also allow the activated electrochemical enzyme to amplify the signal produced by binding of the target nucleic acid to the probe many times. The enzyme converts large amounts of amplification substrate to product by way of active site. In this process, the enzyme is the source or sink for a large number of electrons, which react with the electrodes and produce a detectable electrochemical signal. An exemplary electrochemical enzyme is glucose oxidase, which uses as its amplification substrate glucose to produce gluconolactone. In such variations, flavin-adenine dinucleotide (FAD) has been identified as a useful prosthetic group.

Three different oxidation/reduction enzyme systems are exemplified herein. Each has different potential settings, each function in a unique pH range, they may require redox mediators and lastly, the substrate conditions vary. Reactions schemes are provided for each system.

HRP (horse radish peroxidase) reaction scheme with catechol as the substrate is shown in FIG. 8. Other HRP substrates include, for example, OPD (orthophe-nylene diamine), aminophenols and aromatic polyamines, and reduction of peroxide. The reduction of peroxide occurs via 2H⁺+H₂O₂→I2+2H₂O. However, peroxide may damage certain polymeric porous matrices or membranes. Conversely, catechol redox reactions occur via

Catechol+H₂O₂→Quinone+H₂O

Quinone+2H⁺+2e−→Catechol.

The quinone product generated from this process may be detected amperometrically. Platinum wire electrodes and 0.05 M Na-citrate-phosphate buffer pH 5.0 containing 0.2 M Na₂SO₄ have been found useful in similar detection schemes. The product (quinone) was detected amperometrically:

Quinone+2H⁺+2e−→Catechol.

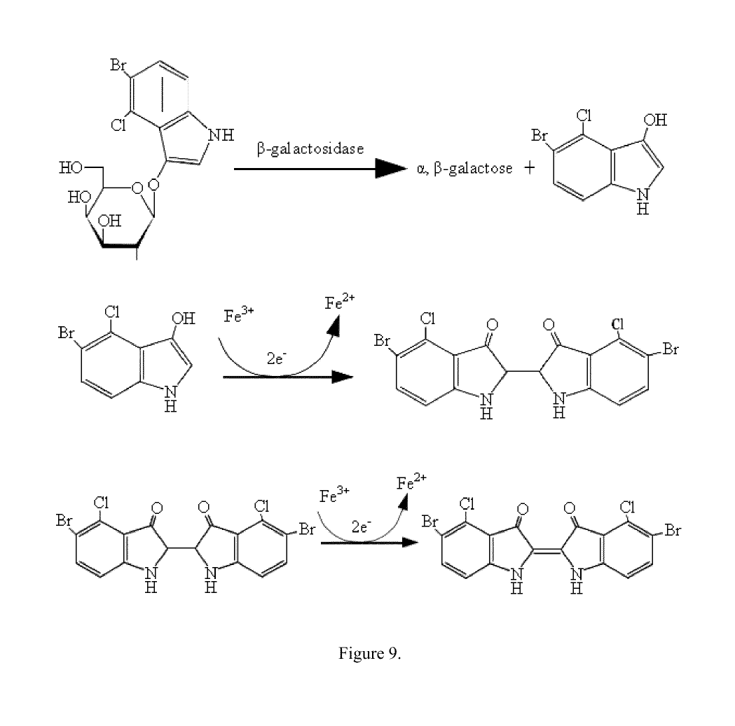

Alternatively, β-Galactosidase may be used to generate an electrical impulse. The reaction, seen in FIG. 9, cleaves penultimate β-galactose residues from oligosaccharides or from glycosyl derivatives. X-Galactose, an indolyl derivative of β-galactopyranoside, may be used as a substrate at a pH 7.0 in 0.01 M PBS buffer. A 0.1 mM X-Gal solution is prepared in DMF, and added to the PBS while vigorously vortexing the aqueous phase to maintain the X-Gal in solution. The instability of this solution requires that a fresh solution needs to be prepared daily. As an alternative, an organic substrate (such as catechol) can be used. The turnover rate for this enzyme is lower than that for other redox enzymes, but the enzyme is very stable at neutral pH.

The X-Gal in itself does not interact well with glass or metal electrodes, necessitating use of an electron mediator, such as ferri/ferro cyanide (50/50) solution, to shuttle electrons to the electrode surface. The electron mediator may be modified as is known in the art to generate amperometric reactions at a 10 mM solution, and higher or lower concentrations for potentiometric reactions.

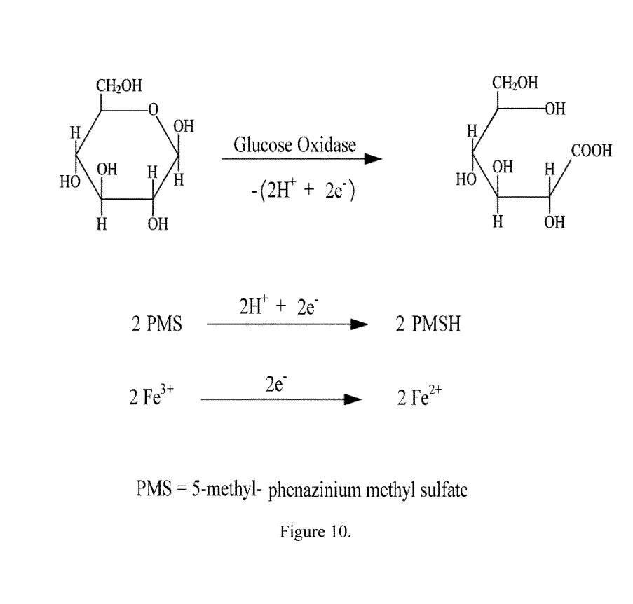

A glucose oxidase reaction scheme may take place at about pH 7.5 in a buffer, such as 0.01M PBS buffer, as seen in FIG. 10. The substrate was glucose and it is extremely soluble in water. The enzyme was regenerated with PMS (5-methyl-phenazinium methyl sul-fate), which in turn utilizes the ferro/ferri cyanide shuttle for detection.

### Example 4

The electrochemical genotyping device may also be manufactured with probe attached to an electrode as a functionalized stick. The functionalized stick is attached to a vibration tray and inserted into a chamber containing target. In some embodiments, the functionalized stick is rotated in the target-containing chamber to enable hybridization. The functionalized stick should rotate fast enough to generate movement for efficient hybridization but not so fast as to disrupt interactions between target in the sample liquid and probes on the substrate. Alternatively, the functionalized stick may be agitated at high speeds to enhance mixing, and then slowed or stopped to enable effective interactions. Agitating the assembly in multiple directions will result in the continuous movement of the cover slip, thus generating movement of the target liquid underneath. This sliding motion provides agitation to move the target molecules of the sample liquid to facilitate better binding with the probes in the microarray.

In some embodiments, the functionalized stick may have protrusions or ridges to enhance the agitation of the target liquid and generate more effective movement of the target liquid underneath. For example, the protrusions can be formed as tooth-like ridges. In an exemplary embodiment, the tooth-like structures are formed as a ridge with a front side that is aligned roughly perpendicular to the surface of the substrate (a 90° angle) and a back side that is at less than a 90° angle to the substrate surface. Because of the shape of these teeth, the liquid is “pumped” to flow preferentially in one direction when the functionalized stick rotates. A small rocking motion can be introduced into the vibration to enhance the pumping action.

After hybridization, the target sample is tested for electrochemical signal generation, as discussed above.

In the preceding specification, all documents, acts, or information disclosed does not constitute an admission that the document, act, or information of any combination thereof was publicly available, known to the public, part of the general knowledge in the art, or was known to be relevant to solve any problem at the time of priority.

The disclosures of all publications cited above are expressly incorporated herein by reference, each in its entirety, to the same extent as if each were incorporated by reference individually.

While there has been described and illustrated specific embodiments of a genomic detection device, it will be apparent to those skilled in the art that variations and modifications are possible without deviating from the broad spirit and principle of the present invention. It is also to be understood that the following claims are intended to cover all of the generic and specific features of the invention herein described, and all statements of the scope of the invention which, as a matter of language, might be said to fall therebetween.

What is claimed is:

1. A device comprising:
a support wafer having a first face and a second face;
at least one detection spot comprising a probe immobilized on the first face of the support wafer or on an electrode, wherein the at least one detection spot is adapted to accept a test sample;
an electroactive label associated with the probe, where the electroactive label is a redox compound, or an apoenzyme label and substrate;
an electron transport mediator selected from the group consisting of ferrocene, isocyanate-derived compounds, phosphines, amines, nanoparticles, ferrocene-containing pyrrole derivatives, ferri/ferro cyanide mixture, derivitized hydrophilic epoxy cements containing pyridinium-N-ethylamine poly-cations, alkane thiol, hydrophilic epoxy cements derivitized to contain electrically conducting pyridinium-N-ethylamine poly-cationic domains, copolymers of allylamine and ferrocene-functionalized acrylic acid, and silicon alkoxide sol-gel matrices doped with electron-transfer mediator;
a well-generating wafer having a first face and a second face, wherein the second face of the well-generating wafer is adapted to fix to the first face of the support wafer, and wherein at least one opening is disposed from the first face to the second face of the well-generating wafer;
a well defined by the support wafer and the well-generating wafer having an enclosed bottom formed from the support wafer, four walls extending from the enclosed bottom, and an exposed opening;
wherein the at least one well confines the at least one detection spot; and
at least one working electrode and one reference electrode forming a plurality of electrodes, wherein the plurality of electrodes are disposed on the first face of the support wafer, disposed on the first face of the well-generating wafer and onto the side of the at least one opening on the well-generating wafer, or disposed on an electrode support wafer and extending adjacent to the at least one opening on the well-generating wafer,
wherein the plurality of electrodes are disposed adjacent to the electroactive label and in electrical communication with the at least one well;
where the electrode support wafer is disposed on the first face of the well-generating wafer.

2. The device of claim 1, wherein the support wafer comprises glass, derivatized glass, plastic, silicon, silicon dioxide, nanocrystalline diamond, polydimethylsiloxane, polymethylmethacrylate, SU-8, coated cellulose, coated nitrocellulose, coated plastic, polypropylene, polyacrylamide, nylon, gold or silver.

3. The device of claim 1, wherein the well-generating wafer comprises glass, derivatized glass, plastic, silicon, silicon dioxide, nanocrystalline diamond, polydimethylsiloxane, polymethylmethacrylate, SU-8, coated cellulose, coated nitrocellulose, coated plastic, polypropylene, polyacrylamide, nylon, or gold.

4. The device of claim 1, wherein the plurality of electrodes comprise metal, conducting polymer, nanostructure materials, conducting paste, or combinations thereof.

5. The device of claim 4, wherein the plurality of electrodes are a metal selected from the group consisting of gold, silver, platinum, copper, colloidal gold, colloidal silver, and colloidal platinum.

6. The device of claim 1, further comprising a first end and second end on the electrode;
wherein the first end is in electrical communication with the sample well in the at least one well and the second end is in electrical communication with an output connector; and
wherein the output connector is adapted to mate with an automated measurement device.

7. The device of claim 1, wherein the probe selected from the group consisting of DNA, DNA mimics, Gruber DNA, RNA, RNA mimics, oligonucleotide, antibody, synthetic oligomer, peptide nucleic acid, full-length cDNA, a less-than full-length cDNA, and a gene fragment.

8. The device of claim 7, wherein the probe is fixed to the first face of the support wafer by a process selected from the group consisting of synthesizing the probe directly on the support wafer, photolithography, printing, ink jet printing, piezoelectric printing, drop touch, spotting, electrochemistry, and oligonucleotide chemistry.

9. The device of claim 1, wherein the enzyme label is selected from the group consisting of horse radish peroxidase, β-galactosidase, and glucose oxidase.

10. The device of claim 1, further comprising a dye disposed in the detection spot, wherein the dye changes color upon addition of a catalyzed product.

11. The device of claim 1, wherein the support wafer is derivatized with isothiocyanate.

12. The device of claim 4, wherein the conducting polymers is selected from the group consisting of oxidized polyacetylene, polypyrrole and polyaniline, iodine-doped polypyrrole, poly(phenylene vinylene), poly(acetylene), poly(pyrrole), poly(thiophene), poly(aniline), poly(fluorene), poly(3-alkylthiophene), polytetrathiafulvalene, polynaphthalene, poly(p-phenylene sulfide), and poly(para-phenylene vinylene).

13. The device of claim 6, wherein the automated measurement device is a multi-channel recorder, a potentiostat, or an intermittent pulse amperometry monitoring system.

14. A method for detecting biological molecules, comprising
exposing at least one test sample suspected of having a biological molecule of interest to a device further comprising:
a support wafer having a first face and a second face;
at least one detection spot comprising a probe immobilized on the first face of the support wafer, wherein the at least one detection spot is adapted to accept a test sample;
an electroactive label associated with the probe, where the electroactive label is a redox compound, or an enzyme label and substrate;
an electron transport mediator selected from the group consisting of ferrocene, isocyanate-derived compounds, phosphines, amines, nanoparticles, ferrocene-containing pyrrole derivatives, ferri/ferro cyanide mixture, derivitized hydrophilic epoxy cements containing pyridinium-N-ethylamine poly-cations, alkane thiol, hydrophilic epoxy cements derivitized to contain electrically conducting pyridinium-N-ethylamine poly-cationic domains, copolymers of allylamine and ferrocene-functionalized acrylic acid, and silicon alkoxide sol-gel matrices doped with electron-transfer mediator;
a well-generating wafer having a first face and a second face, wherein the second face of the well generating wafer is adapted to fix to the first face of the support wafer, and wherein at least one opening is disposed from the first face to the second face of the well-generating wafer;
a well defined by the support wafer and the well-generating wafer having an enclosed bottom formed from the support wafer, four vertical walls extending from the enclosed bottom, and an exposed opening;
wherein the at least one well confines the at least one detection spot; and
at least one working electrode and one reference electrode forming a plurality of electrodes, wherein the plurality of electrodes are disposed on the first face of the support wafer, disposed on the first face of the well-generating wafer and onto the side of the at least one opening on the well-generating wafer, or disposed on an electrode support wafer,
wherein the plurality of electrodes are disposed adjacent to the electroactive label and in electrical communication with the sample in the at least one well;
where the electrode support wafer is disposed on the first face of the well-generating wafer; and
testing the at least one electrode for a signal generated from the at least one detection spot;
wherein a signal from the at least one detection spot is indicative of the test sample having the biological molecule of interest.

15. The method according to claim 14, wherein the probe is selected from the group consisting of DNA, DNA mimics, Gruber DNA, RNA, RNA mimics, oligonucleotide, antibody, synthetic oligomer, peptide nucleic acid, full-length cDNA, a less-than full-length cDNA, and a gene fragment.

16. The method according to claim 14, wherein the biological molecules are selected from the group consisting of biomarkers, DNA, RNA, and protein.

17. The method according to claim 14, wherein the enzyme label is selected from the group consisting of horse radish peroxidase, β-galactosidase, and glucose oxidase.
